(19) United States
(12) Patent Application Publication
(10) Pub. No.: US 2022/0177736 A1
(43) Pub. Date: Jun. 9, 2022

(54) Heat-shrinkable adhesive tape

(71) Applicant: Zhijun PENG, Foshan (CN)

(72) Inventor: Zhijun PENG, Foshan (CN)

(21) Appl. No.: 17/540,227

(22) Filed: Dec. 1, 2021

(30) Foreign Application Priority Data
Dec. 5, 2020 (CN) 202011404362.9

(51) Int. Cl. C09J 7/20

(52) U.S. Cl. CPC C09J 7/20; C09J 2301/16; C09J 2301/312

(57) ABSTRACT

A heat-shrinkable adhesive tape, including the tape body, which includes a heat-shrinkable sheet portion and non-heat-shrinkable sheet edge portions respectively provided on the two sides of the heat-shrinkable sheet portion. The bottom surface of each of the non-heat-shrinkable sheet edge portions is provided with an adhesive layer. The heat-shrinkable sheet portion is in the center and non-heat-shrinkable sheet edge portions are on the two sides, while the bottom surface of each of the non-heat-shrinkable sheet edge portions is provided with an adhesive layer such that the non-heat-shrinkable sheet edge portions provide adhesion while the heat-shrinkable sheet portion shrinks under heat and narrows down the gap of the object. The gap of the object will be narrower and the object will be sealed more firmly.

### BACKGROUND OF THE INVENTION

The present invention relates to adhesive tape and more particularly pertains to a heat-shrinkable adhesive tape.

The packing tape in the present art adheres to two closure pieces of a box by the adhesive strength of the adhesive layer. The width of the gap between the two closure pieces is controlled by the amount of force manually applied on the box before applying the adhesive tape. The packing tape neither controls nor narrows down the gap between the closure pieces of the box. A published Chinese patent application under the title “Heat-shrinkage adhesive tape and preparation method thereof” (CN105111810A; Patent application no.: 201510572854.1) disclosed a heat-shrinkable and pressure-sensitive adhesive tape which comprises a substrate, a pressure sensitive adhesive layer and a detachable material laminated sequentially from top to bottom. When the heat-shrinkable and pressure-sensitive adhesive tape is heated up to the suitable temperature of shrinkage, the tape shrinks in an unidirectional manner without any shrinking along the widthwise direction. The heat-shrinkable and pressure-sensitive adhesive tape, based on the shape of the object to be adhered to, firmly adheres the electronic components in irregular shape between the tape and the object to be adhered to, to increase the yield rate of good quality product. Yet, due to the structural design, the tape is only suitable for the adhesion of electronic components but not for sealing boxes.

### BRIEF SUMMARY OF THE INVENTION

In view of the aforesaid disadvantages now present in the prior art, the present invention provides a heat-shrinkable adhesive tape, which comprises a heat-shrinkable sheet portion in the center and non-heat-shrinkable sheet edge portions on the two sides. The bottom surface of each of the non-heat-shrinkable sheet edge portions is provided with an adhesive layer. The non-heat-shrinkable sheet edge portions provide adhesion while the heat-shrinkable sheet portion shrinks under heat and applies a closing force to the gap of the object applied with the adhesive tape so that the gap of the object will be narrower and the object will be sealed more firmly.

To attain this, the present invention adopts the following technical solution: a heat-shrinkable adhesive tape, comprises the tape body, characterized in that the tape body comprises a heat-shrinkable sheet portion and non-heat-shrinkable sheet edge portions respectively provided on the two sides of the heat-shrinkable sheet portion. The bottom surface of the each of the non-heat-shrinkable sheet edge portions is provided with an adhesive layer.

Furthermore, the two sides of the heat-shrinkable sheet portion corresponding to the inner edges of the non-heat-shrinkable sheet edge portions are provided with shrinkage holes.

Furthermore, the heat-shrinkable sheet portion and the non-heat-shrinkable sheet edge portions are fixed as an integral structure.

Furthermore, each of the non-heat-shrinkable sheet portions is 38-42 μm thick; the adhesive layer is 15-18 μm thick; the heat-shrinkable sheet portion is 15-25 μm thick.

The benefits of the present invention: the present invention comprises a heat-shrinkable sheet portion and non-heat-shrinkable sheet edge portions respectively provided on the two sides of the heat-shrinkable sheet portion. The bottom surface of the each of the non-heat-shrinkable sheet edge portions is provided with an adhesive layer. The non-heat-shrinkable sheet edge portions provide adhesion while the heat-shrinkable sheet portion shrinks under heat and applies a closing force to the gap of the object so that the gap of the object will be narrower and the object will be sealed more firmly. When applied on sealing boxes, the present invention narrows the gap of the box so as to control the width of the gap of the box. With a narrower gap, the box is sealed with a better quality. The technical solution of the present invention may be used as packing tape and electrical tape, etc.

### BRIEF DESCRIPTION OF THE DRAWINGS

FIG. 1 shows the schematic perspective view of the present invention.

### DETAILED DESCRIPTION OF THE INVENTION

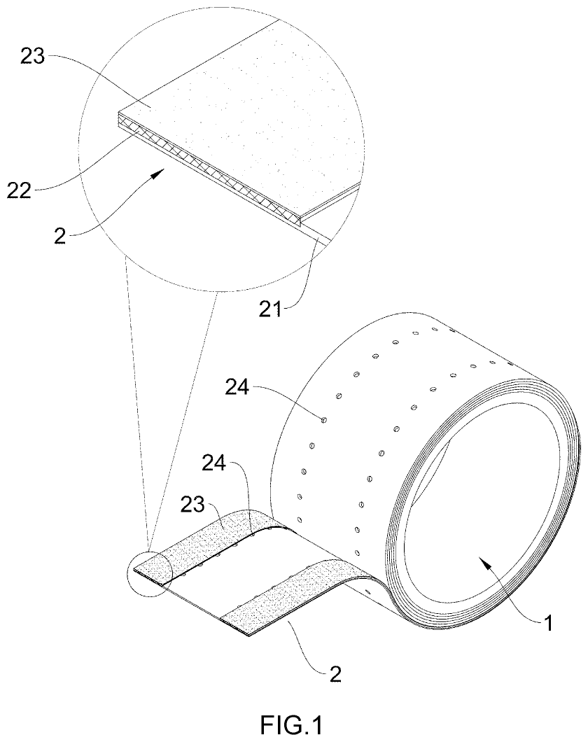

As illustrated in FIG. 1, a heat-shrinkable adhesive tape, comprises a winding reel 1 and a tape body 2 winding around the winding reel 1. The tape body 2 comprises a heat-shrinkable sheet portion 21 and non-heat-shrinkable sheet edge portions 22 respectively provided on the two sides of the heat-shrinkable sheet portion 21. The heat-shrinkable sheet portion 21 and the non-heat-shrinkable sheet edge portions 22 are fixed as an integral piece. The bottom surface of each of the non-heat-shrinkable portions 22 is provided with an adhesive layer 23. When the present invention is used as a packing tape, the non-heat-shrinkable sheet edge portions 22 adhere to the two closure pieces that define a gap of the box. The heat-shrinkable sheet portion 21 shrinks under heat and creates a binding force to narrow down the gap of the box. The present invention may be processed into sheets and provided with a detachable paper layer on the adhesive layer 23. The present invention may also be processed into a roll so that the present invention also comprises a winding reel 1, and the tape body 2 is wound around the winding reel 1 as illustrated in FIG. 1.

For more regular shrinkage which does not affect the adhesion of the non-heat-shrinkable sheet edge portions 22, as illustrated in FIG. 1, two sides of the heat-shrinkable sheet portion 21 corresponding to inner edges of the non-heat-shrinkable sheet edge portions 22 are respectively provided with shrinkage holes 24. The shrinkage holes 24 allow the heat-shrinkable sheet portion 21 to shrink more regularly, and hence will not pull off the adhesion of the non-heat-shrinkable sheet edge portions 22 nor cause deformation or wrinkling of the non-heat-shrinkable sheet edge portions 22.

For a better balance between the cost and the performance of the present invention, each of the non-heat-shrinkable sheet edge portions 22 is 38-42 μm thick and the adhesive layer 23 is 15-18 μm thick. The heat-shrinkable sheet portion 21 is 15-25 μm thick.

The above content presents the preferred embodiments of the present invention but does not limit the protection scope thereof. Changes and improvements made by a person skilled in this field of art in accordance with the scope of teachings of the present invention without deviating from the inventive concept of the present invention should also fall within the scope of protection of the present invention.

What is claimed is:

1. A heat-shrinkable adhesive tape, comprising a tape body (2), characterized in that: the tape body (2) comprises a heat-shrinkable sheet portion (21) and non-heat-shrinkable sheet edge portions (22) respectively provided on two sides of the heat-shrinkable sheet portion (21); a bottom surface of each of the non-heat-shrinkable portions is provided with an adhesive layer (23).

2. The heat-shrinkable adhesive tape according to claim 1, wherein two sides of the heat-shrinkable sheet portion (21) corresponding to inner edge of the non-heat-shrinkable sheet edge portions (22) are respectively provided with shrinkage holes (24).

3. The heat-shrinkable adhesive tape according to claim 1, wherein the heat-shrinkable sheet portion (21) and the non-heat-shrinkable sheet edge portions (22) are fixed as an integral structure.

4. The heat-shrinkable adhesive tape according to claim 1, wherein each of the non-heat-shrinkable sheet portions (22) is 38-42 μm thick and the adhesive layer (23) is 15-18 μm thick.

5. The heat-shrinkable adhesive tape according to claim 1, wherein the heat-shrinkable sheet portion (21) is 15-25 μm thick.

6. The heat-shrinkable adhesive tape according to claim 1, also comprising a winding reel (1); the tape body (2) is wound around the winding reel (1).
